(19) United States
(12) Patent Application Publication
(10) Pub. No.: US 2003/0037715 A1
(43) Pub. Date: Feb. 27, 2003

(54) Weed removal tool

(76) Inventors: Cathy D. Santa Cruz, Reno, NV (US); David W. Imeson, Fallon, NV (US); Burt D. Imeson, Fallon, NV (US)

Correspondence Address: Cathy D. Santa Cruz, 7630 Tholl Drive, Reno, NV, 89506, US

(21) Appl. No.: 09/940,294

(22) Filed: Aug. 27, 2001

(51) Int. Cl. A01C 23/02; A01B 45/00; A01B 45/02; A01B 1/00

(52) U.S. Cl. 111/7.1; 172/22; 172/371

(57) ABSTRACT

A weed removal tool which may be completely formed from typical tubular metal stock. The tool is of very simple construction having only a handle, an elongated member, a foot peg, and weed expulsion means, also the tool does not include any moving parts. Furthermore, “if desired” the tool may be used in conjunction with an herbicide so as to inhibit any further growth of the weed.

### FIELD OF THE INVENTION

This invention relates in general to weeding devices but more particularly pertains to a weed removal tool that alleviates backbreaking work, as the tool can be easily used while the worker is in an upright standing position. The tool is especially useful for removing not only the top portion of the weed, but most “if not all” of the root system as well. Most importantly, the tool is of very simple construction, is sturdy, and is extremely easy to use.

### BACKGROUND OF THE INVENTION

There are many types of lawn and garden tools which can be utilized to remove weeds from the ground surface and underlying soil. Most of these tools have few or no moving parts and instead rely on fixed position blades of one configuration or another for facilitating weed removal. Although inexpensive to manufacture, substantial manual effort is often required to remove the weeds from the ground or to remove the weed plug from the device. Much of the prior art in this field may have been efficient at removing part of the weed, but they are not successful at eliminating the troublesome root system. Such examples may include embodiments shaped like a small shovel, trowel, fork, hoe, etc., as seen in U.S. Pat. Nos. 5,484,653, 5,469,923, 5,386,681, 5,360,071, 5,207,466. U.S. Pat. Nos. 1,939,897, 2,210,440, and 2,378,459 share the same goal of weed extraction. However, their structures are somewhat weak, therefore less effective, and also require greater effort during use. Another example of inferior prior art is U.S. Pat. No. 2,439,524, which is obviously less durable as it relies on a single, narrow primary shaft, an equally inadequate foot peg, as well as includes the evident possibility that this tool could be potentially dangerous, due to the upright protruding member extending from the handle which is not only an obstruction but could also easily injure the user.

Other types of weed pulling or similar devices include moveable blade-like members that are lever actuated and configured to penetrate the ground and grasp the weed upon actuation by the operator. Examples of such devices are shown in U.S. Pat. Nos. 5,535,833, 5,476,298, 5,154,465, 5,476,248, 654,904, 652,077, 774,142, 630,946 and 182,367. Because these types of tools require the operator to squeeze a hand-actuated lever to actuate the blade-like members for removal of the weed and soil plug, a significant amount of hand strength as well as upper body strength is often required. Thus, greater effort and strength is particularly needed during operation in ground conditions such as heavily compacted soil, rocky ground, or high clay content.

Other known types of weeding devices employ rotating members configured for penetrating the ground, such as drill bits or augers, for exterminating the weed and corresponding root structure. Examples of such devices are shown in U.S. Pat. Nos. 5,865,259, 5,491,963, 3,444,934, 2,763,222 and 500,538. Tools of this type, however, can be relatively complex and difficult to operate, costly to manufacture, and may be more prone to breakage than the foregoing types.

Another example of a known weed-pulling device is shown in U.S. Pat. No. 5,234,241. This patent discloses a manually operable weed remover consisting of a cluster of pivotal spikes guided by a bottom flange and pivotally attached to a handle. When the device is positioned over the center of a weed and downward pressure is applied, the flange is forced upward by the ground, and the spikes are forced into the ground in a converging motion around the weed and the plug is released from the device by actuation of a rod attached to a central knob or T-shaped handle. One drawback of the radial spikes and guide flange arrangement is that the narrow spikes can become bent from the repeated collapsing movement over prolonged use, particularly in rocky conditions. If even one spike becomes bent or otherwise out of radial alignment with the other spikes, the device becomes completely inoperable.

As such, there is a continuing need for new and improved manually operable garden tools which are simple to manufacture and which at the same time require less physical assertion to remove the weed, and which remain operable even when used for prolonged periods of time, even when subjected to difficult soil conditions. In these and other aspects, the present invention overcomes the inherent disadvantages and drawbacks of the known prior art and substantially fulfills this need.

### SUMMARY OF THE INVENTION

It is therefore an object of the present invention to provide a weed removal tool which overcomes the inherent disadvantages and drawbacks associated within the known prior art.

It is another object of the present invention to provide a weed removal tool which can be formed from one piece of typical tubular stock which is most advantageous and cost effective.

Yet another object of the present invention is to provide a weed removal tool which is of very simple construction and does not include any moving parts which may break when subjected to wear and tear over a prolonged period of time.

Still another important object of the present invention is to provide a weed removal tool which can be easily used while the worker is in an upright standing position, thus reducing backaches and unnecessary bending associated within the known prior art.

Yet another object of the present invention is to provide a weed removal tool which is extremely easy to use by anyone having fundamental knowledge. Thus the user need not be a skilled laborer.

A further object of the present invention is to provide a weed removal tool which is more efficient than the prior art when used in difficult ground conditions such as compacted soil or rocky ground. In certain situations it may be helpful for the worker to saturate the surrounding soil as this will simplify removal of the weed.

Also, another object of the present invention is to provide a weed removal tool which if is so desired, may include instructions for applying a weed-killing substance thereon, such as a typical prior art herbicide or the like.

Other objects and advantages will be seen when taken into consideration with the following specification and drawings.

### BRIEF DESCRIPTION OF THE DRAWINGS

FIG. 1 is substantially a perspective overview of the preferred embodiment for the present invention and depicts a first position before removal of the weed.

FIG. 2 is substantially a partial perspective view of the preferred embodiment for the present invention and depicts a second position after removal of the weed.

### DETAILED DESCRIPTION OF THE DRAWINGS

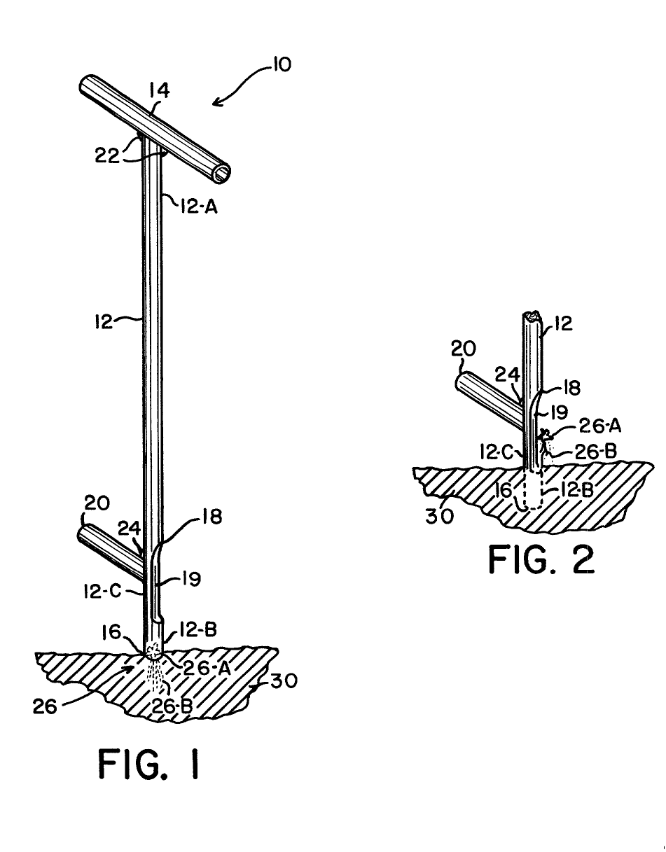

Referring now in detail to the drawings wherein like characters refer to like elements throughout the various views. As depicted in FIG. 1, (10) substantially represents an overview for the preferred embodiment for the weed removal tool of the present invention. It is to be understood the following specification is only exemplary of the one possible embodiment, and thus other configurations within the scope of the claims are to be inherent including obvious variations according to engineering choice.

Weed removal tool (10) is substantially formed from an integrally formed elongated vertical tubular member (12) having a top end (12-A), a bottom end (12-B), and a lower section (12-C). With the top end (12-A) having a handle (14) fixedly mounted thereon. Bottom end (12-B) is horizontally cut forming substantially a circular sharp cutting edge (16), with lower section (12-C) having substantially a partial cutout (18) forming an opening (19) and lower section (12-C) also having a horizontal foot peg (20) mounted thereon.

As depicted in FIGS. 1 and 2, it can clearly be seen foot peg (20) and opening (19) are substantially opposed to each other. Also, it is to be understood circular sharp cutting edge (16) and partial cutout (18) are in open communication with each other.

It is to be further understood that integrally formed elongated vertical tubular member (12) can be made from substantially any suitable material of engineering choice, such as typical metal tubular stock, that may be in the form of iron, steel, or any other strong material, etc. Also, if so desired, handle (14) and foot peg (20) may as well be formed from the same tubular stock as integrally formed elongated vertical member (12). This is most advantageous and cost effective, as this provides a very strong evenly formed tool with each of the components having substantially the exact outside circumference and inside radius.

Still further it is to be understood that handle (14) may be fixedly attached onto top end (12-A) by any suitable attachment means of engineering choice, such as by welding (22), brackets, or the like. Also, handle (14) is to be horizontally mounted onto top end (12-A) in relation to integrally formed elongated vertical tubular member (12). Also as an option, handle (14) is so desired may include handgrips, (not shown).

Furthermore, foot peg (20) may be fixedly attached onto lower section (12-C) by any suitable attachment means of engineering choice, such as by welding (24), brackets, or the like. Also, foot peg (20) is to be horizontally mounted onto lower section (12-C) in relation to integrally formed elongated vertical tubular member (12).

It is to be further understood that tool (10) includes an additional novel feature which was not found within the known prior art. Namely, if so desired, bottom end (16) and lower section (12-C) may have a weed-killing substance applied thereon, such as a typical prior art herbicide or the like. Again, any suitable type of herbicide may be used and it may be applied by any suitable manner of user choice, such as by spraying or the like.

It can now be clearly seen that when integrally formed elongated vertical tubular member (12) is vertically aligned directly above a weed (26), with circular sharp cutting edge (16) being positioned around the exposed protruding top portion (26-A) of weed (26) (as depicted in FIG. 1) and a downward force is exerted upon foot peg (20), circular sharp cutting edge (16) cuts into the surrounding earth (30) in a manner which captures the root system (26-B) of weed (26) along with exposed protruding top portion (26-A) of weed (26), and root system (26-B) of weed (26) along with exposed protruding top portion (26-B) of weed (26) is automatically forced into and expelled outwardly away from within opening (19), (as depicted in FIG. 2).

Although the invention has been herein shown and described in what is conceived to be the most practical and preferred embodiment, it is recognized that departures may be made there from within the scope and spirit of the invention, which is not to be limited to the details disclosed herein but is to be accorded the full scope of the claims so as to embrace any and all equivalent devices and apparatus's.

What we claim as new and wish to secure by letters patent is:

1. A weed removal tool comprising: an integrally formed elongated vertical tubular member having a top end; a bottom end; and a lower section; said top end having a handle fixedly mounted thereon, said bottom end being horizontally cut forming a circular sharp cutting edge, said lower section having a partial cut-out forming an opening, said lower section having a horizontal foot peg fixedly mounted thereon, said circular sharp cutting edge and said partial cut-out being in open communication, and said foot peg and said opening being substantially opposed to each other, whereby:
when said integrally formed elongated vertical tubular member is vertically aligned directly above a weed, with said circular sharp cutting edge being positioned around the exposed protruding top portion of said weed, and a downward force is exerted upon said foot peg, said circular sharp cutting edge cuts into the surrounding earth in a manner which captures the root system of said weed along with said exposed protruding top portion of said weed, and said root system of said weed along with said exposed protruding top portion of said weed is automatically forced into and expelled outward from within said opening.

2. The weed removal tool of claim 1 is made from metal.

3. The weed removal tool of claim 1 wherein said handle is formed from the same tubular stock as said elongated vertical tubular member, thus said handle and said elongated vertical tubular member each having substantially the exact outside circumference and inside radius.

4. The weed removal tool of claim 1 wherein said lower section having a horizontal foot peg fixedly mounted thereon, includes said horizontal foot peg being mounted by welding, and said horizontal foot peg is horizontally mounted in relation to said integrally formed elongated vertical tubular member.

5. The weed removal tool of claim 1 wherein said foot peg is formed from the same tubular stock as said elongated vertical tubular member, thus said foot peg and said elongated vertical tubular member each having substantially the exact outside circumference and inside radius.

6. The weed removal tool of claim 1 wherein said handle is fixedly attached onto said top end by welding, and said handle is horizontally mounted in relation to said integrally formed elongated vertical tubular member.

7. The weed removal tool of claim 1 further includes said bottom end and said lower section having a weed-killing substance applied thereon.
